(19) United States
(12) Patent Application Publication
(10) Pub. No.: US 2014/0230069 A1
(43) Pub. Date: Aug. 14, 2014

(54) Secure Asynchronous Multichannel Communication

(71) Applicant: Kenneth Lee Milman, Los angeles, CA (US)

(72) Inventor: Kenneth Lee Milman, Los angeles, CA (US)

(21) Appl. No.: 13/766,653

(22) Filed: Feb. 13, 2013

(51) Int. Cl. H04L 29/06

(52) U.S. Cl. CPC H04L 63/04
USPC 726/26

(57) ABSTRACT

In exemplary embodiments of a system and method for secure asynchronous multichannel communication, an original message is obtained which includes a named subject and confidential information pertaining to that named subject. The original message is parsed into at least a first component message and a second component message. The first component message includes the named subject and an anonymous unique identifying token tethered to the named subject. The first message does not include the confidential information. The second component message includes the confidential information and not the named subject. The first component message is sent to an authorized recipient by way of a first communication channel. A personal identification code is received from the authorized recipient. The second component message is then provided to the authorized recipient by way of a second communication channel, which is distinct from the first communication channel.

### RELATED APPLICATIONS

This application claims the benefit of U.S. Provisional Application No. 61/633,591 filed Feb. 13, 2013, the content of which is incorporated by this reference in its entirety for all purposes as if fully set forth herein.

### TECHNICAL FIELD

The present invention relates generally to methods for delivering a message securely from one entity to another without the aid of a thin client.

### BACKGROUND

There are occasions when it is desirable to communicate information from one party to another using computers or handheld digital equipment in a secure fashion. This requirement for secure communications arises as a result of regulations, business or personal demands to keep information private and to prevent it from falling in the hands of unauthorized or unintended parties. The actual information could take any form: audio, audio-visual, visual, textual, or any combination such as in multi-media messages or content.

This problem with transmitting and receiving a message securely arises regardless of whether the message is transmitted using wired or wireless communication. In both cases, it is conventionally possible for the message to be intercepted or received by an unauthorized party either by accident or by intentional eavesdropping.

There are many instances for when such privacy in message transmission is desired as illustrated in the following examples.

### Example #1

Imagine that a physician has a patient or (many) patients who have undergone some form of diagnostic procedure that is executed by a third party such as a medical lab. This is how almost all lab tests are now done in the United States. A doctor or his staff might take blood or a tissue specimen from a patient, but will have the actual analysis performed by a professional lab. This third party lab must report the result to the physician in such a manner that only the physician can have access to the results. The physician, in a separate communication and at his or her discretion might then want to advise the patient of the results or consequences of the results. In this case each link in a multi-chain communication must be secure. In this example, there are two specific communication chains that must be guarded for privacy: (1) Lab-to-Physician, and (2) Physician-to-Patient. This particular example is one of federally mandated regulation: the Health Insurance Portability and Accountability Act of 1996 (HIPAA) privacy rule is passed by the US Congress and enforced by the U.S. Department of Health and Human Services.

### Example #2

Imagine that two people want to engage in a private conversation. For instance, suppose a man wants to plan a surprise birthday party for his wife. In order to effectively plan such a party, he wants to communicate with one or more of his wife's best friends to help him identify the invitees to the party. In order to preserve the special surprise nature of the party, neither he nor his fellow party-planners—his wife's friends—want this communication to be exposed. There are many examples where our personal lives impose a demand for security in our communications.

### Example #3

Imagine a business or government agency whose job demands the secure transmission of information. The information in this case might be of a proprietary nature that could have unwanted economic effects if it fell into the wrong hands. Such information might entail a pending merger or acquisition, pending state or federal legislation, crop reports, or raw or refined intelligence being circulated to sister law enforcement or intelligence agencies.

One typical method already in existence for providing message security is to install a coding/decoding software program at both ends of the transmission chain such that both clients (the sender and recipient) possess the means to encode or decode the message. This technique constitutes a viable solution to the problem of secure communication but requires the installation of proprietary software that is not always simple or desirable. When one or both communication devices is a handheld or portable device such as a cell phone, installing special purpose software (e.g., ‘thin client’) may not suit a user's needs or wants and may not fulfill privacy regulatory requirements of government agencies such as the HIPAA guidelines.

### SUMMARY

Certain deficiencies of the prior art may be overcome by the provision of one or more embodiments of a system or method for transmitting a message securely. Moreover, certain embodiments may provide one or more non-transitory computer readable media having stored thereon software program code operable to cause one or more processors to collectively perform steps or operations of the methods described herein.

An original message may be obtained which may include a named subject and confidential information pertaining to that named subject, such as a patient's lab test results. The original message may then be parsed into at least a first component message and a second component message. The first component message may include the named subject and an anonymous unique identifying token tethered to the named subject. The first message typically would not include the confidential information. Rather, the second or further component messages would include the confidential information, without including the named subject.

The first component message may be sent to an authorized recipient by way of a first communication channel. At that point, the authorized recipient may review the first component message. A personal identification code (e.g., PIN) of the authorized recipient may then be received from the authorized recipient, along with the respective token included in the first component message. In particular embodiments, the token itself may actually be comprised of a solicitation to enter the authorized recipient's personal identification code, the entry of which initiates the step of providing the second component message within several seconds or minutes of the entry. The second component message may be provided to the authorized recipient by way of a second communication channel. In preferred embodiments, the second communication channel is distinct from the first communication channel.

Embodiments of the invention constitute a novel method for delivering a message securely from one client to another within the aid of a thin client. This is valuable because some users do not want or have access to such software on their mobile or other devices or because sometimes, one of the channels may not involve an embedded computer. Embodiments of the invention generally parse a single message into component messages and then delivers those component messages using different preferably one-way or asynchronous channels such as SMS alerts, voicemails, telephone conversation, email, or posting to a social network. Only the authorized recipient has the means to see and understand the relationship between the two messages.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic depiction of an undivided message dialog which, if intercepted, would reveal private information pertaining to an individual or entity, as well as the identity of the respective person or entity;

FIG. 2 is a diagrammatic depiction of a first component message delivered via a first channel which, if intercepted, would only reveal the identity of the respective person or entity to which private information pertains; and

FIG. 3 is a diagrammatic depiction of a second component message delivered via a second channel which, if intercepted, would only reveal private information pertaining to a person or entity not directly identified in the second component message.

FIG. 4 is a diagrammatic depiction of an embodiment of a first component message delivered via a first channel and comprised of a solicitation to enter the authorized recipient's PIN, the entry of which rapidly initiates the step of providing the second component message to the authorized recipient; and

FIG. 5 is a diagrammatic depiction of a second component message associated with the embodiment of FIG. 4, wherein a second component message is rapidly delivered via a second channel following entry of the PIN by the authorized recipient.

### DETAILED DESCRIPTION OF THE PREFERRED EMBODIMENTS

Referring now to the drawings, like reference numerals designate identical or corresponding features throughout the several views.

The term “channel” as used herein may refer to one or more telecommunication pathway. See the entry below titled ‘Multi-channel’ for examples of these telecommunication pathways. The channel client type is not essential and could refer to communication between two mobile devices or a mobile device and a non-mobile device.

The term “thin client” as used herein may refer to an executable software package installed on a user's computer system or mobile device.

The term “multi-channel as used herein may refer to two or more different channels. A multi-channel system is a system that implements any combination of two or more methods of message transmission. These channels may include but are not limited to: (1) telephonic, (2) voicemail, (3) text messaging, (4) (SMS) alert messaging, (5) facsimile (FAX), (6) email, (7) posted or published messages to a website, electronic bulletin board, newspaper, publication, or social network, (8) instant messaging

The term “PIN” as used herein may refer to a Personal Identification Number, such as an alphanumeric password.

The term “UID” as used herein may refer to a Unique Identifier. This could be any system generated unique identifier, typically an alphanumeric code.

“Med Lab,” “Donald Doctor,” and “Pamela Patient” are all fictitious proper names used for illustration purposes and are not intended to depict a resemblance to actual persons or companies.

The term “Asynchronous” as used herein may refer to one-way communication

The present invention generally involves parsing a single confidential message into two (or more) discrete component messages such that both component messages are independently benign if intercepted or viewed by an unauthorized party. Further, added security of transmitting these discrete messages from one client to another may be provided via use of different channels for each component message. This concept can be illustrated using an application that is designed to address the problem from EXAMPLE 1, above. Consider a medical laboratory that is in possession of a patient's lab results diagnosed with AIDS. In certain parts of society, having a positive diagnosis for this disease constitutes a social stigma. The laboratory would typically be interested in alerting the physician of the result but must exercise extreme discretion in doing so. Furthermore, there are many cases when the transmission of such information could not be exercised by telephone.

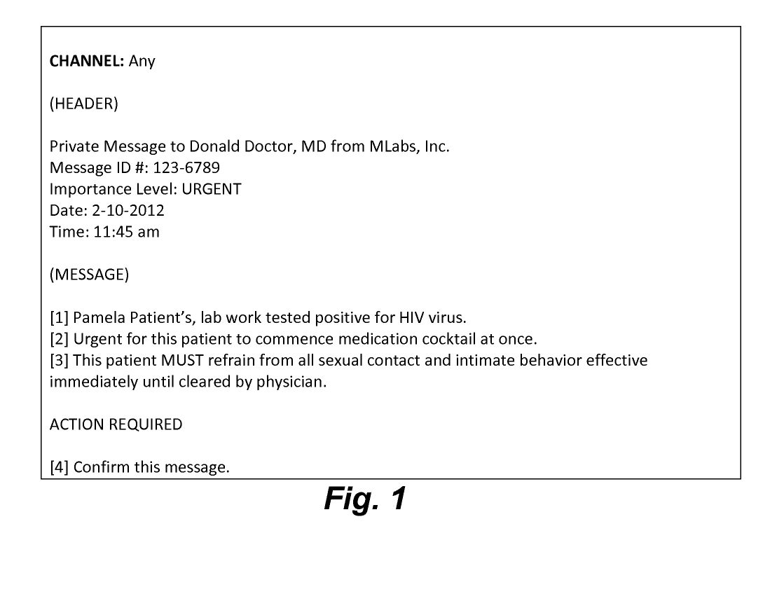

If the message shown in FIG. 1 were intercepted or viewed by an unauthorized party it could be devastating to the lab, the patient and the doctor. Imagine that a doctor's mobile device were misplaced or lost and that the mobile device was found by an unauthorized user who gained access to the doctor's voice mail or text messages. This person might well tell others and the patient's confidentiality and reputation would have been irreparably violated. Embodiments of the present invention are intended to help prevent unauthorized access to private messages or other confidential communications.

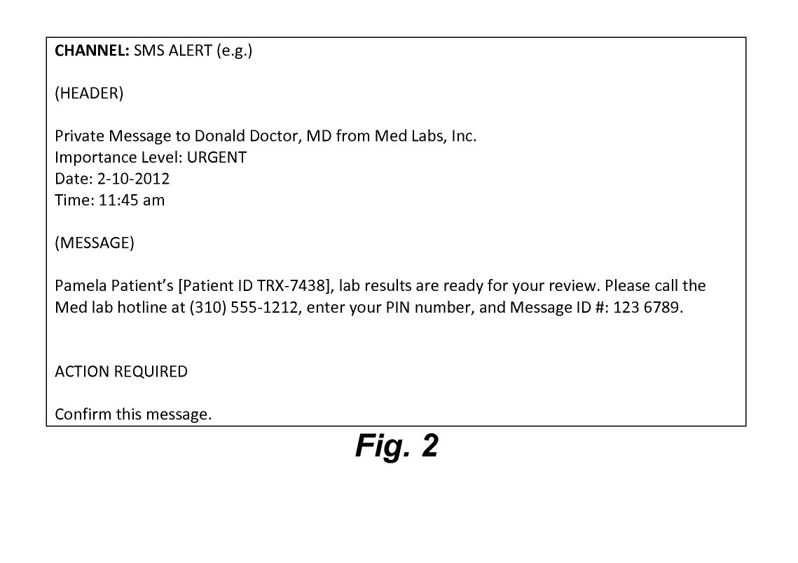

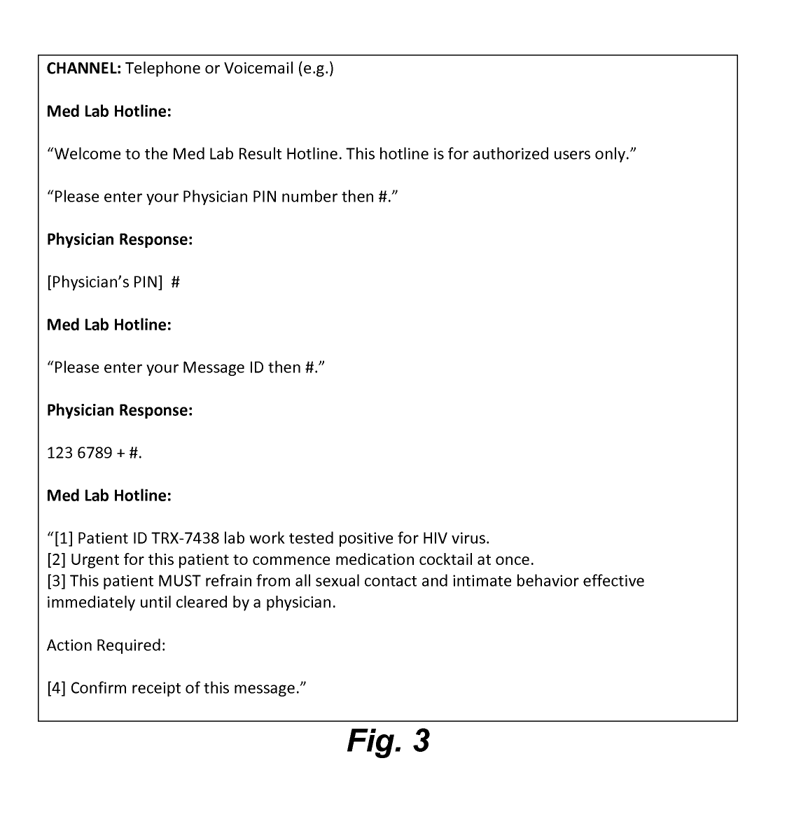

Embodiments of the method typically parse the original message into two innocuous segments. For example, the first message from FIG. 1 above may be rendered as depicted between FIGS. 2 and 3.

In FIG. 2 ‘TRX-7438’ is provided as a hypothetical system generated unique identifier to refer to the patient ‘Pamela Patient’ in subsequent message transmissions. A Message ID may be provided as additional identifying information for this message. At this point, the physician could disconnect from the text or email system and dial the diagnostic lab hotline phone number. A dialogue such as that shown in FIG. 3 may then ensue.

Notice that if either message contained in FIG. 2 or 3 were intercepted, it would not reveal anything secret or embarrassing about the patient. Only the authorized party, in this case the doctor, would possess the requisite link to connect the two component messages together.

Preferred embodiments of the present invention make use of the delivery of both messages using different channels. The salient feature is not which different channels, but that both messages are transmitted using any two (or more) different channels. This is important because it is extremely unlikely that an unauthorized party would have the ability to intercept both component messages if transmitted along different channels. Receiving clients would be encouraged to refrain from keeping the content of both messages (e.g. from FIG. 2 and FIG. 3) on a single device unless one of those messages was encrypted or hidden.

Preferred embodiments of this patent deals with any communication from an organization to an individual such as cited in EXAMPLE 1, above where a medical laboratory might want to provide results of a patient's lab work to a physician. It is easy to see that other information of a confidential nature could also be conveyed from one client to another absent extra ‘thin client software’. The ability to secure and preserve privacy from unauthorized parties without using specialized software or a thin client is advantageous. Embodiments of the present invention may be applicable to all such scenarios including those where a business, government agency, private individual, or any organization is conveying information to anyone else and wishes to transmit that information securely and without said thin client software. These alternative embodiments are intended to be included within the domain of this invention.

A computer-implemented method of transmitting a message securely may include a series of steps or operations, such as those discussed below or otherwise herein. Systems for facilitating such computer implementations may involve one or more processors, servers, databases, data storage devices, network connections and internal encryption schemes. Moreover, certain embodiments may include one or more non-transitory computer readable media having stored thereon software program code operable to cause one or more processors to collectively perform steps or operations of the methods described below or otherwise herein.

An original message may be obtained which may include a named subject and confidential information pertaining to that named subject, such as a patient's lab test results. The original message may then be parsed into at least a first component message and a second component message. The first component message may include the named subject and an anonymous unique identifying token tethered to the named subject. The first message typically would not include the confidential information. Rather, the second or further component messages would include the confidential information, without including or otherwise directly identifying the named subject.

The first component message may be sent to an authorized recipient by way of a first communication channel. At that point, the authorized recipient may review the first component message. A personal identification code (e.g., PIN) of the authorized recipient may then be received from the authorized recipient, along with the respective token included in the first component message. The second component message may then be provided to the authorized recipient by way of a second communication channel. In preferred embodiments, the second communication channel is distinct from the first communication channel.

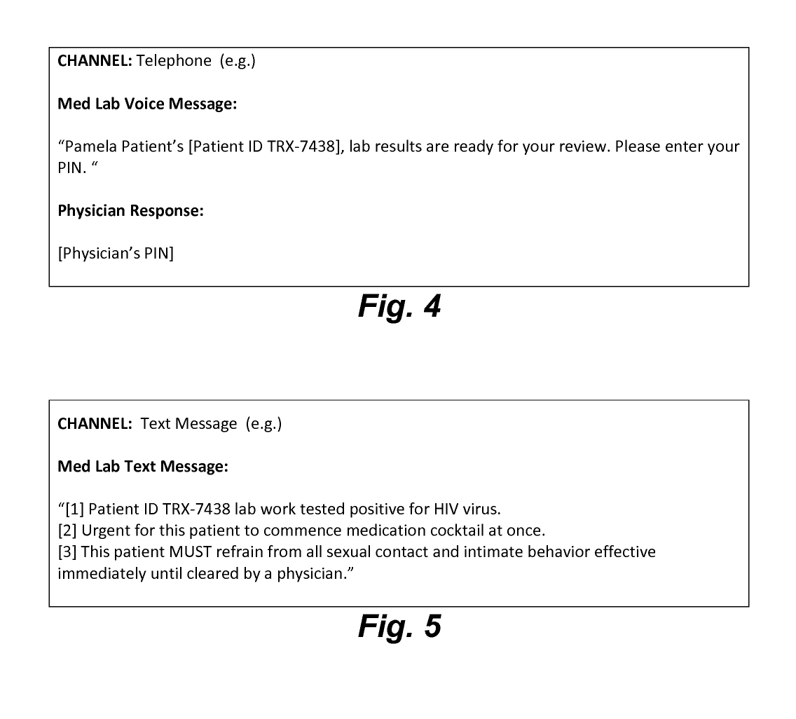

In certain preferred embodiments, such as those depicted in the combination of FIGS. 4 and 5, the token itself may actually be comprised of a solicitation to enter the authorized recipient's personal identification code (e.g., PIN), the entry of which initiates or “triggers” the step of providing the second component message within seconds or a few minutes of the PIN's entry. For example, in particular embodiments, a physician may receive a phone call with the first component message illustrated in FIG. 4. Upon entering her PIN via her phone's keypad, the same physician may almost immediately receive a text message with the contents of the second component message (as illustrated, for example, in FIG. 5). The close temporal proximity of the PIN entry and provision of the second component message signals to the physician that the respective first and second component messages directly relate to one another. Depending upon the particular embodiments, such temporal proximity may be, for example, substantially instantaneous, within 30 seconds, within 2 minutes, or the like.

In certain embodiments, the step of receiving may preferably be way of the respective second communication channel. Depending upon the particular embodiment, the named subject may be the proper name of a natural person to whom said confidential information pertains (as illustrated in FIGS. 2 and 3, for example), or may be the name of a non-human entity to which said confidential information pertains, such as a business or government agency.

In particular embodiments, the first communication channel is SMS alert and the second communication channel is telephone. In alternative embodiments, only one of the first communication channel and the second communication channel may be text messaging. In further alternative embodiments, only one of the first communication channel and second communication channel may be SMS alert. In additional alternative, only one of the first communication channel and second communication channel may be telephone.

In certain preferred embodiments, the original message may be obtained from a medical lab, the named subject may be a medical patient and the authorized recipient may be a physician of the patient. Depending upon the embodiment, the PIN and, where applicable, a separate message token, may be received by way of the second communication channel or the first communication channel. Similarly to certain of the embodiments described above, in certain embodiments, authorized recipients may be automatically contacted via the second communication channel and provided the second component message a short time (e.g., within 30 seconds) after they send their PIN and token back via, for example, the first communication channel.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer-implemented method of transmitting a message securely, said method comprising:
obtaining an original message including a named subject and confidential information pertaining to said named subject;
parsing said original message into at least a first component message and a second component message, said first component message including said named subject and an anonymous unique identifying token tethered to said named subject, said first message not including said confidential information, said second component message including said confidential information and not including said named subject;
sending said first component message to an authorized recipient by way of a first communication channel; and
providing said second component message to said authorized recipient by way of a second communication channel, said second communication channel being distinct from said first communication channel.

2. A method as defined in claim 1 wherein said token is comprised of a solicitation to enter the authorized recipient's personal identification code, the entry of which initiates said step of providing within two minutes of said entry.

3. A method as defined in claim 1 further comprising:
after said step of sending and before said step of providing, receiving from said authorized recipient a personal identification code of said authorized recipient and entry of said token, wherein said token is distinct from said personal identification code.

4. A method as defined in claim 3 wherein said step of receiving is by way of said first communication channel.

5. A method as defined in claim 1 wherein said named subject is the proper name of a natural person to whom said confidential information pertains.

6. A method as defined in claim 1 wherein said named subject is the name of a business or government agency to which said confidential information pertains.

7. A method as defined in claim 1 wherein said first communication channel is telephone and said second communication channel is text messaging.

8. A method as defined in claim 1 wherein only one of said first communication channel and said second communication channel is text messaging.

9. One or more non-transitory computer readable media having stored thereon software program code operable to cause one or more processors to collectively perform operations comprising:
obtaining an original message including a named subject and confidential information pertaining to said named subject;
parsing said original message into at least a first component message and a second component message, said first component message including said named subject and an anonymous unique identifying token tethered to said named subject, said first message not including said confidential information, said second component message including said confidential information and not including said named subject;
sending said first component message to an authorized recipient by way of a first communication channel;
receiving entry of said token from said authorized recipient; and
providing said second component message to said authorized recipient by way of a second communication channel, said second communication channel being distinct from said first communication channel.

10. A method as defined in claim 9 wherein said token is comprised of a solicitation to enter the authorized recipient's personal identification code, the entry of which initiates said step of providing within two minutes of said entry.

11. A method as defined in claim 9 wherein said step of receiving is by way of said first communication channel.

12. A method as defined in claim 9 wherein said named subject is the proper name of a natural person to whom said confidential information pertains.

13. A method as defined in claim 9 wherein said named subject is the name of a business or government agency to which said confidential information pertains.

14. A method as defined in claim 9 wherein said first communication channel is SMS alert and said second communication channel is telephone.

15. A method as defined in claim 9 wherein only one of said first communication channel and said second communication channel is telephone.

16. A method as defined in claim 9 wherein only one of said first communication channel and said second communication channel is SMS alert.

17. A method as defined in claim 9 wherein only one of said first communication channel and said second communication channel is text messaging.

18. A method as defined in claim 9 wherein said original message is obtained from a medical lab, said named subject is a medical patient and said authorized recipient is a physician of said patient.

19. A method of transmitting an original message by dividing said original message into two or more discrete component messages such that one of the component messages contains a unique, anonymous, identifying token tethered to the essential identifying data from said original message and another of the component messages references said token without any inclusion of said essential identifying data.

20. A method as defined in claim 19 further comprising transmitting said discrete component messages via two or more different telecommunications channels to an intended recipient of said original message.
